(19) United States
(12) Patent Application Publication
(10) Pub. No.: US 2009/0261106 A1
(43) Pub. Date: Oct. 22, 2009

(54) Apparatus for Holding Trash Can Liners in Place

(76) Inventor: John Stelmach, Prescott, AZ (US)

Correspondence Address: STURM & FIX LLP, 206 SIXTH AVENUE, SUITE 1213, DES MOINES, IA, 50309-4076, US

(21) Appl. No.: 12/107,275

(22) Filed: Apr. 22, 2008

(51) Int. Cl. B65F 1/06; B65D 25/14; B65D 25/20

(52) U.S. Cl. 220/495.11; 220/694

(57) ABSTRACT

A device for holding in place a flexible bag, such as a plastic garbage bag, that is attached to the outside wall of a trash can, or molded into the top portion of a trash can. The invention is a resilient one piece clamp formed of an elastomeric material. The clamp has complementary projections and indentations respectively on mating surfaces of the first and second portions of the clamp that hold the bag in place. The present invention can have two embodiments: one being a clamp attached to adhesive material that attaches to the outside wall of a trash can, the other embodiment is where the entire garbage can and clamp is of one piece construction.

### CROSS REFERENCE TO RELATED APPLICATIONS

Not applicable

### BACKGROUND OF THE INVENTION

1. Field of the Invention

The present invention relates generally to a device for holding in place a flexible bag, such as a plastic garbage bag, that is attached to the outside edge or molded into the top edge of an open top receptacle, such as a trash can or wastepaper basket.

2. Description of the Prior Art

After inserting a plastic garbage bag into a trash receptacle, the problem is when trash is placed in the receptacle, whatever is placed in the can pulls the bag off the edge of the receptacle and part or all of the plastic bag falls inside the trash can with the trash.

Two categories of inventions have been made to try to help with this problem. Most closely related to this invention are clips that are placed inside a trash can or over the rim of a trash can to hold a trash bag in place. These types of clips are represented by U.S. Pat. No. D510,019, to Davis and U.S. Pat. No. 5,735,495 to Kubota, which are incorporated herein by reference. The problem with these clips is that they can be easily lost.

Another category includes hoops, rings, rims, or bands that clamp around the edge or top of the rim of a trash can or around the edge of a holding rim. Examples of this category are U.S. Pat. No. 3,614,041 to Koger; U.S. Pat. No. 4,765,579 to Robbins, III; U.S. Pat. No. 5,641,138 to Cronk; and U.S. Pat. No. 5,556,063 to Boyd which are also incorporated herein by reference. The problems with these inventions is either 1) the hoop or band, etc. cannot fit a variety of shaped trash cans, since they are made for one specific shape and size of receptacle, or 2) the framework holding the trash bag has no bottom to support heavy trash items, such as liquids.

Accordingly, there is a need for garbage can bag holders on trash can containers which overcome the aforementioned problems.

### BRIEF SUMMARY OF THE INVENTION

The present invention relates generally to a device for holding in place a flexible bag, such as a plastic garbage bag, that is attached to the outside edge of the trash can, or built in into the perimeter of the top portion of a trash can.

The present invention includes a resilient one piece clamp formed of an elastomeric material. It is unlike prior art in that it has complementary projections and indentations respectively on mating surfaces of the first and second portions of the clamp. It is also unlike prior art in that it is either attached to the outside of a trash can or molded into the top portion of a trash can.

An object of the present invention is to provide a means of keeping a bag in a trash can from falling inside the trash can when it is filled.

Another object of the invention is to provide a way to release the bag from the said clamp so that the waste does not spill, especially in the case of toxic waste.

Other objects, advantages, and novel features of the present invention will become apparent from the following detailed description of the invention when considered in conjunction with the accompanying drawings.

### BRIEF DESCRIPTION OF THE DRAWINGS

FIG. 1-a is a perspective view of a first embodiment of present invention showing a clamp with adhesive material attached.

FIG. 1-b is a cross section of FIG. 1-a, showing the clamp, formed out of an elastomeric material, and the adhesive material.

FIG. 2 is another perspective view of the present invention, showing how one could peel off the backing of the adhesive material, such as double-sided tape.

FIG. 3 is another perspective view and shows how the present invention can be placed on the top outside wall of a trash can.

FIG. 4-a is a perspective view and shows the trash bag in the trash can, draped over the trash can edge and its top open edge placed up inside the clip.

FIG. 4-b is a cross section of FIG. 4-a showing the trash bag in the trash can, draped over the trash can edge and its top open edge placed up inside the clip.

FIG. 5-a is a perspective view of the trash can with a partial cross section of the upper section of the trash can showing an example of how the present invention can be an entire garbage can and clamp of one piece construction.

FIG. 5-b is an enlarged perspective view of the present invention with a partial cross section of the upper section of the trash cans showing how the clamp can be opened by pulling out the outer part of the clamp with one's finger.

### DESCRIPTION OF THE PREFERRED EMBODIMENTS

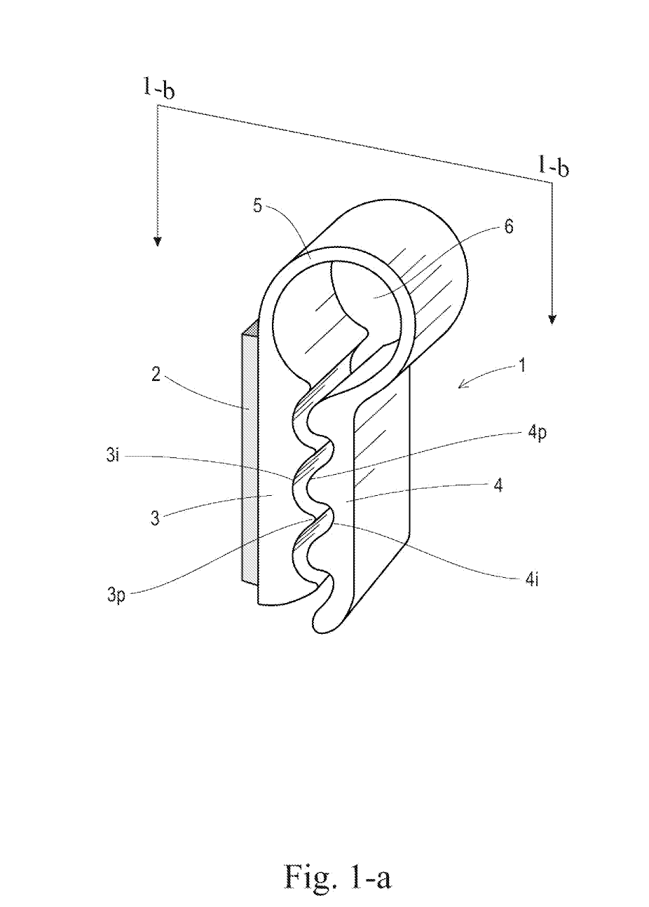

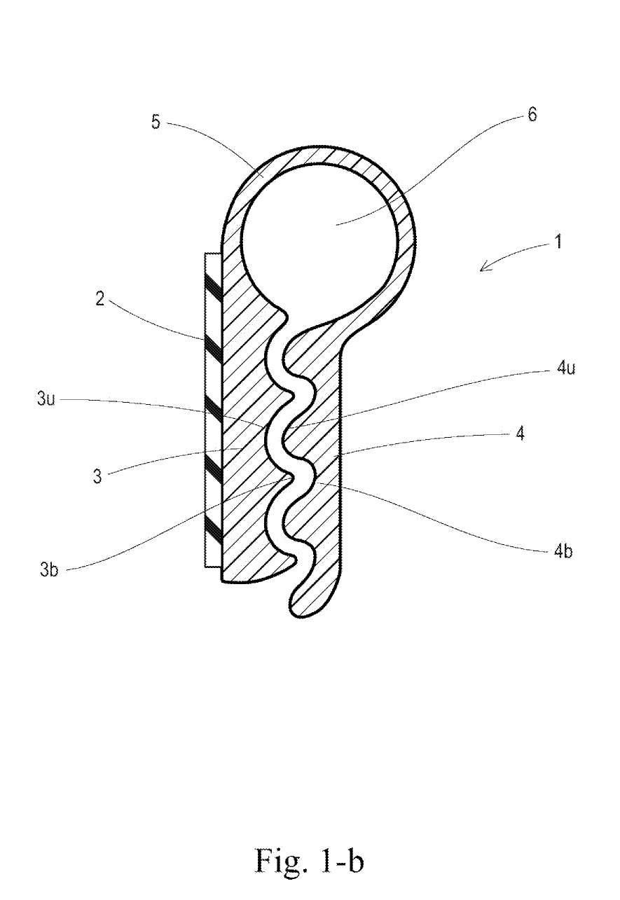

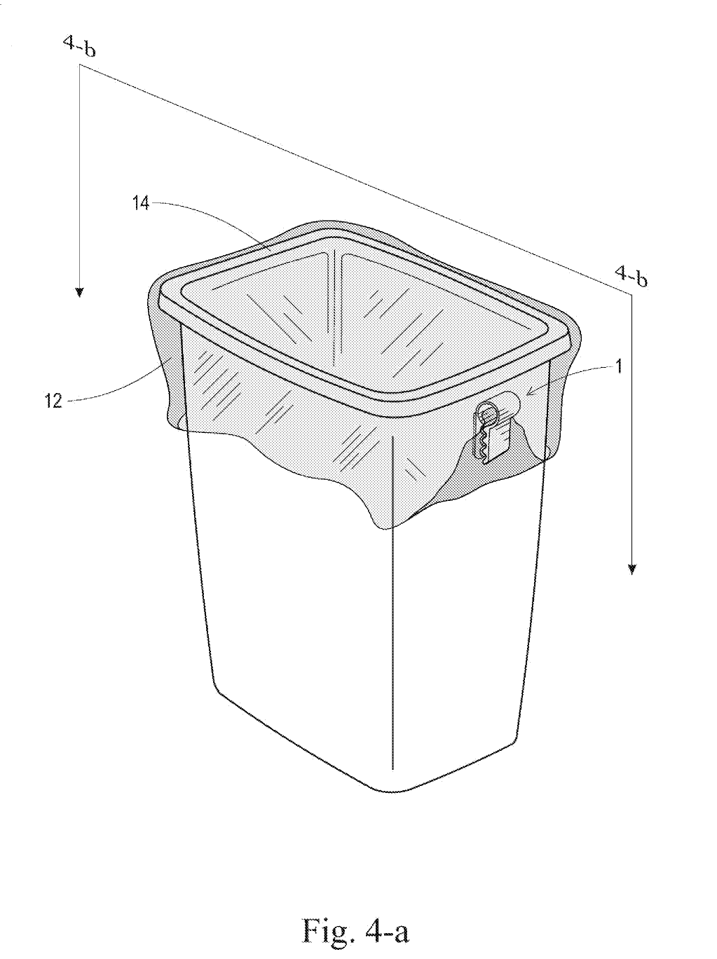

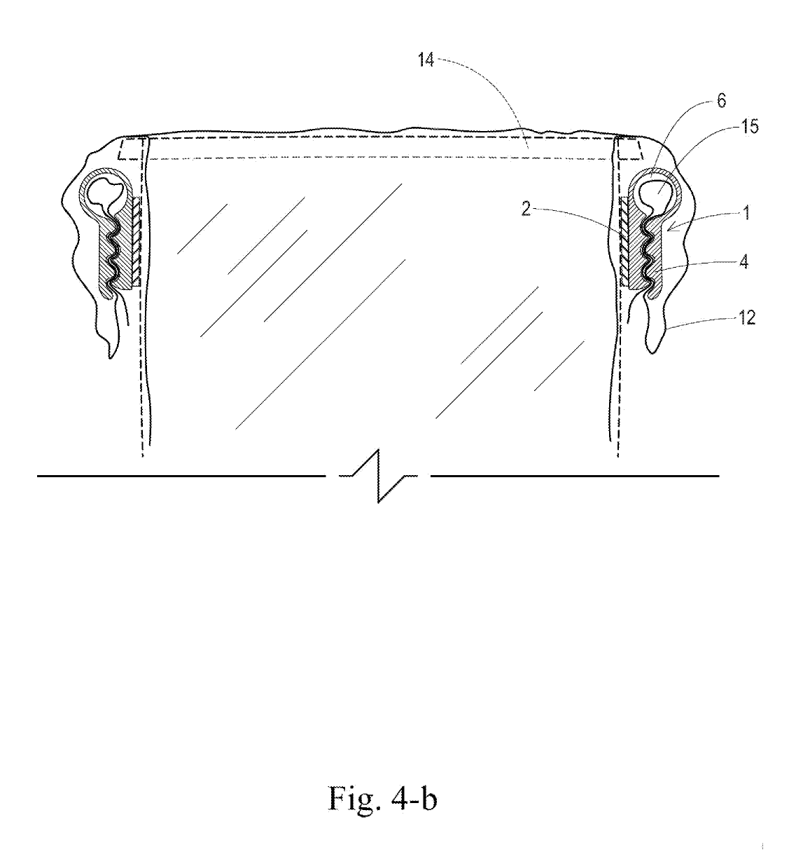

Referring now to the drawings wherein like numerals designate identical or corresponding parts throughout the several views, FIG. 1-a shows the first embodiment of the present invention, a resilient one piece clamp 1 formed out of an elastomeric material, such as polyvinyl chloride, attached to an adhesive material 2, which can be double sided tape. The clamp 1 consisting of two portions: the first portion 3 being the portion closest to the adhesive material 2, and the second portion 4 being the portion not connected to the adhesive material 2. Both portions 3, 4 have complementary projections 3p, 4p and indentations 3i, 4i, respectively, on mating surfaces. Connecting the two portions is a hinge 5 and inside the hinge 5 is a storage area 6 to be used to stuff any excess portions 15 of the trash bag 14, as shown for example in FIG. 4-b.

Referring now to FIG. 1-b, each of the two portions 3, 4 can be considered to have an upper and lower portion, the upper parts 3u, 4u, and the bottom parts 3b, 4b. The plastic bag 14 can be inserted at the location between the bottom portions 3b, 4b of clamp 1.

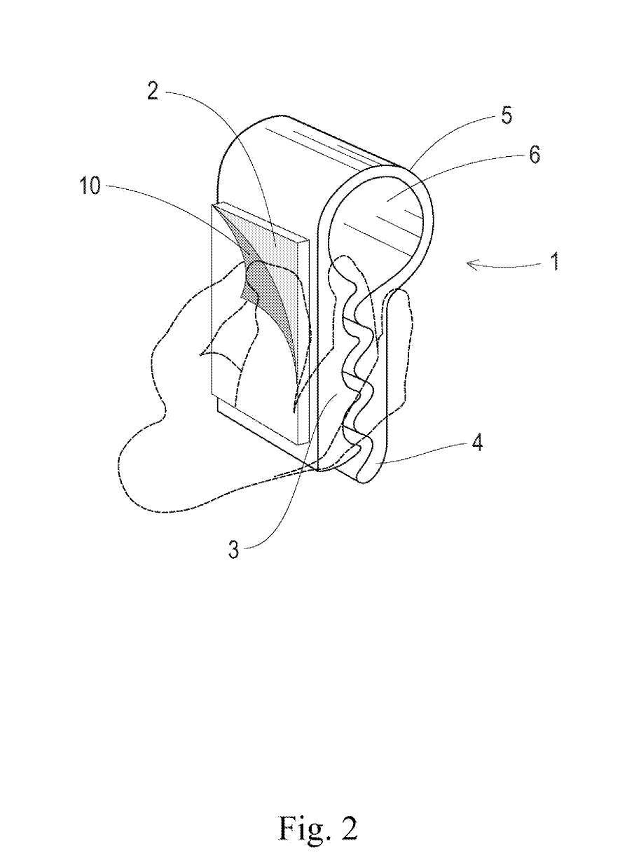

Referring now to FIG. 2, the backing 10 can be peeled off the back of the double sided tape adhesive 2.

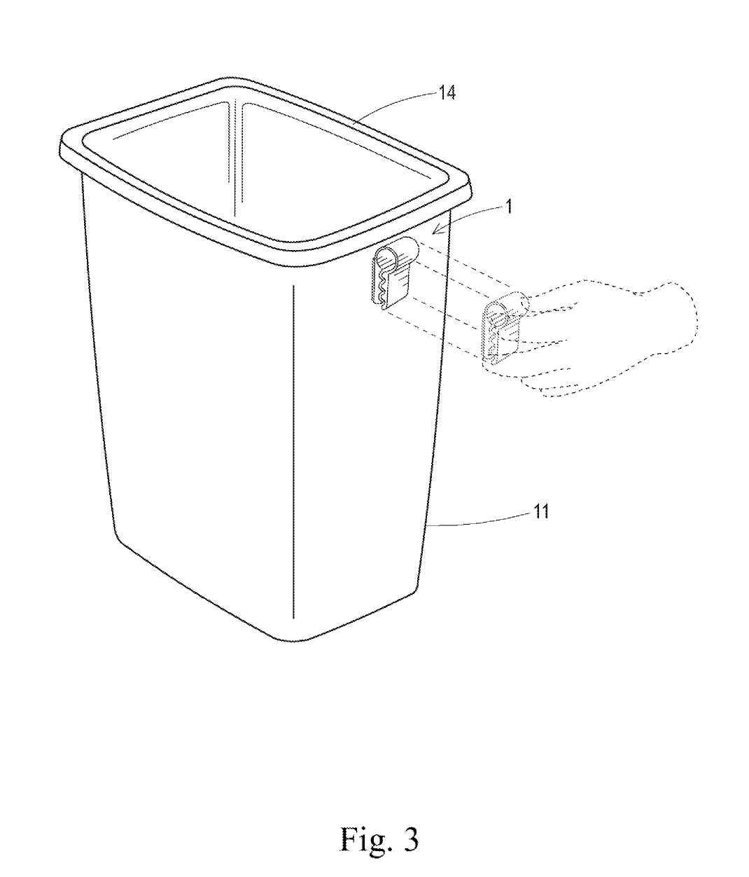

Referring now to FIG. 3, the clamp 1 with the adhesive material 2 can be placed on the upper outside wall of the trash can 11.

The plastic bag or liner 12 can be placed inside the trash can as shown in FIG. 4-a.

As shown in FIG. 4-b, the top portion of the open end of the plastic bag 12 can be draped over the trash can rim 14 and inserted into the clamp 1 between the complementary projections and indentations 3p, 4p, 3i, 4i of the clamp 1. The storage area 6 is utilized for extra storage of the top of the plastic bag 12.

The plastic bag 12 is held firmly in place with constant pressure by the complementary projections and indentations 3p, 4p, 3i, 4i of the 1 by the natural resiliency of the plastic material and the fact that the two portions 3,4 of the clamp 1 are very close together or barely touching. The number of complementary projections and indentations 3p, 4p, 3i, 4i depends on the holding strength required.

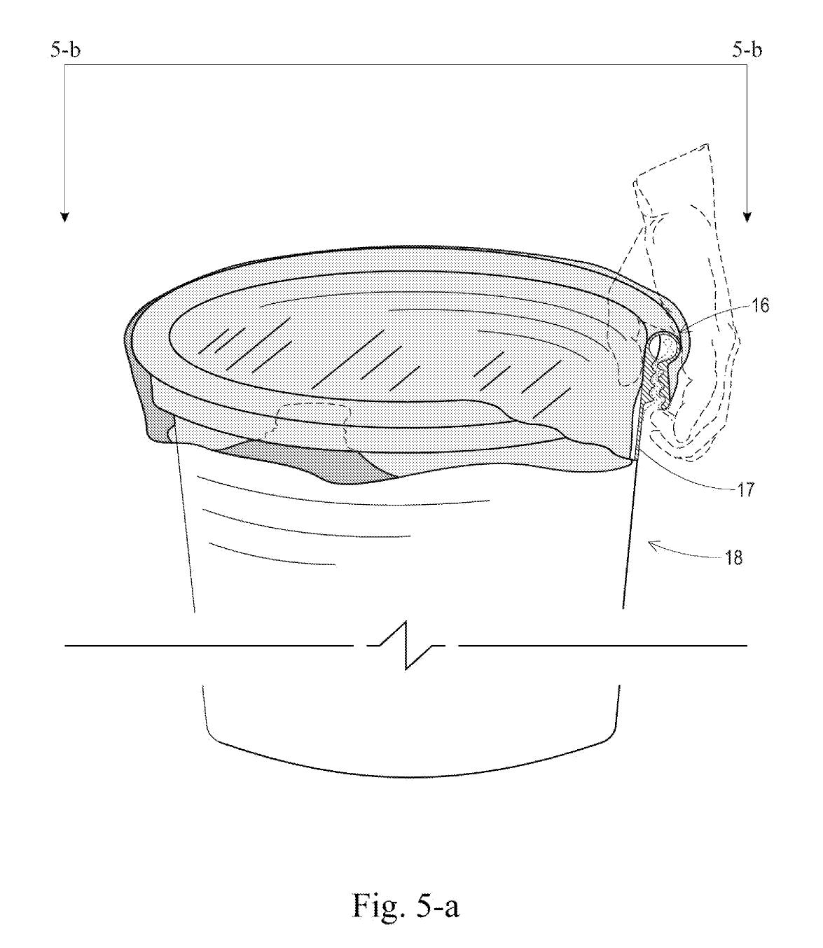

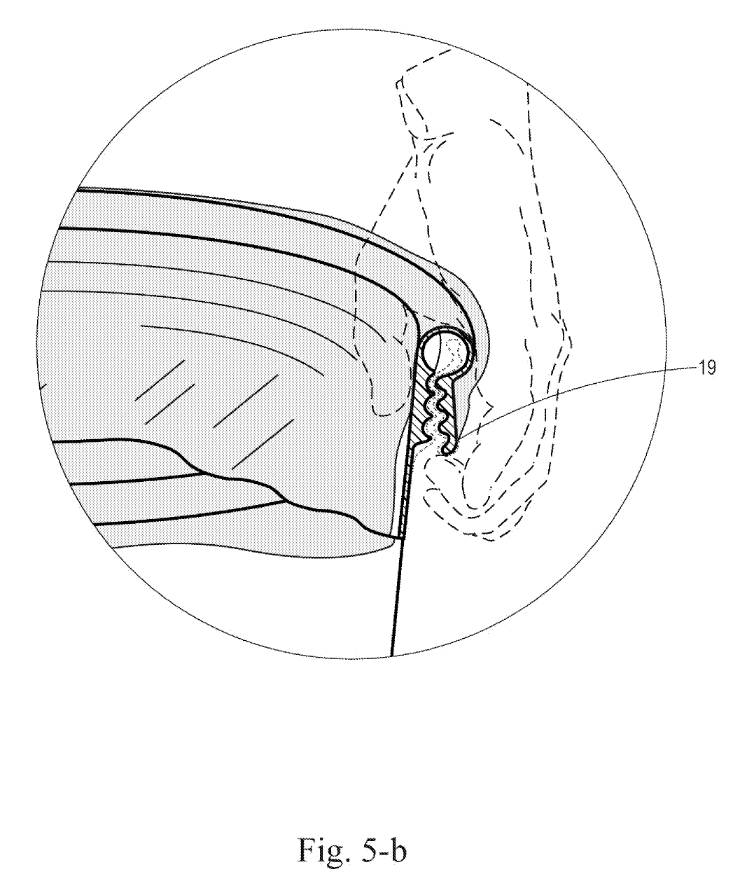

FIG. 5-a shows the second embodiment of the present invention, where the clamp 16 is a one piece construction with the upper vertical wall 17 being part of the one piece 16. The entire garbage can 18 and the clamp 16 is of one piece construction.

Referring now to FIG. 5-b, there is a finger pull portion 19 placed on the second portion of the clamp 4 for use in inserting or removing the bag. This can be particularly helpful in avoiding tearing the plastic bag 12 when it is removed, especially important in the case of toxic waste.

Obviously many modifications and variations of the present invention are possible in light of the above teachings. It is therefore to be understood that, within the scope of the appended claims, the invention may be practiced otherwise than a specifically described.

I claim:

1. Apparatus comprising:
a garbage can having bottom and a mostly vertical wall attached to the bottom and extending three hundred and sixty degrees around the bottom to form an container, the vertical wall having an inside and an outside and an upper rim around an upper periphery of the vertical wall;
a plastic garbage bag being disposed in the garbage can with an open top of the garbage bag being folded over the upper rim of the vertical wall;
a resilient one piece clamp formed of an elastomeric material, said clamp being operatively attached to a top outside portion of the vertical wall, said claim having a first portion closer to the vertical wall than a second portion thereof, the first portion having a top and a bottom and the second portion having a top and a bottom, and a hinge portion connecting the first and second portions of the clamp at the respective top thereof;
a storage area located below the hinge and between the first and second portions of the clamp, closer to the top than the bottom of the first and second portions; and
the bottom of the second portion having a first position in close proximity to the bottom of the first portion and a second position spaced away from the bottom of the first portion whereby the top portion of the plastic bag can be inserted between wherein it is disposed between the first and second portions and stuffed into the storage area, whereby the second portion of the clamp can be released and the top portion of the plastic bag will be held in the storage area and between and in contact with the bottom portions of the first and second portions of the clamp.

2. The apparatus of claim 1 wherein the clamp is attached to the vertical wall with adhesive material.

3. The apparatus of claim 1 wherein there are at least two of the clamps attached to the outside of the vertical wall.

4. The apparatus of claim 1 where there are complementary projections and indentations respectively on mating surfaces of the first and second portions of the clamp.

5. The apparatus of claim 1 wherein the clamp is attached to and extends completely around the outside of the upper rim of the vertical wall.

6. The apparatus of claim 5 wherein the clamp is a one piece construction with the upper vertical wall being part of said one piece.

7. The apparatus of claim 6 wherein the entire garbage can and clamp is of one piece construction.
